(19) United States
(12) Patent Application Publication
(10) Pub. No.: US 2017/0317800 A1
(43) Pub. Date: Nov. 2, 2017

(54) FEEDBACK METHOD FOR SUPPORTING INTERFERENCE RANDOMIZATION AND APPARATUS THEREFOR

(71) Applicant: LG ELECTRONICS INC., Seoul (KR)

(72) Inventors: Kungmin PARK, Seoul (KR); Heejeong CHO, Seoul (KR); Hyunsoo KO, Seoul (KR); Hyeyoung CHOI, Seoul (KR); Ilmu BYUN, Seoul (KR)

(73) Assignee: LG ELECTRONICS INC., Seoul (KR)

(21) Appl. No.: 15/526,050

(22) PCT Filed: Nov. 17, 2014
(86) PCT No.: PCT/KR2014/011012

§ 371 Date: May 11, 2017

(51) Int. Cl. H04L 5/00; H04W 28/04

(52) U.S. Cl. CPC H04L 5/0032; H04L 5/0048; H04W 28/048

(57) ABSTRACT

The present invention relates to a feedback information transmission method for supporting interference randomization in a wireless system and an apparatus using the same. The feedback information transmission method comprises the steps of: receiving, from a base station, information for an interference pattern including an inter-cell interference measurement reference signal, and a trigger condition for change in the interference pattern; measuring interference randomization gains on the basis of the inter-cell interference measurement reference signal; determining whether to request a change in the interference pattern on the basis of the interference randomization gains; requesting a change in the interference pattern to the base station, if it is determined to request a change in the interference pattern; and receiving, from the base station, the changed interference pattern and the changed trigger condition.

### BACKGROUND OF THE INVENTION

### Field of the Invention

The present invention relates to mobile communications, and more particularly, to a feedback method for supporting interference randomization and an apparatus for the same.

### Related Art

A transmission mode based on orthogonal frequency-division multiplexing access (OFDMA) may independently allocate one or more subcarriers to each user equipment (UE). Thus, it is possible to efficiently allocate frequency resources without intra-cell frequency interference at a UE's request.

In a cellular network system, system performance may significantly change depending on the location of a terminal in a cell. Particularly, inter-cell interference may substantially degrade the performance of a terminal located on the boundary of the cell. Further, with higher frequency reuse efficiency, a high data transmission rate may be obtained in the center of the cell, while inter-cell interference becomes serious. Accordingly, the terminal on the boundary receives significant interference from a neighboring cell and thus has a greater decrease in signal-to-interference-plus-noise ratio (SINR).

In order to mitigate inter-cell interference in an orthogonal frequency-division multiple access (OFDMA) cellular network system, studies have been conducted on techniques for avoiding inter-cell interference, techniques for averaging inter-cell interference effects, and techniques for eliminating inter-cell interference.

In a current cellular network system, there are a large number of moving cells. Inter-cell interference may occur between moving cells and fixed cells. Methods are needed to mitigate interference between moving cells and fixed cells.

### SUMMARY OF THE INVENTION

One embodiment of the present invention provides a method for adjusting an interference pattern and for adjusting a rank depending on a channel condition of a transmitter performing interference randomization, and an apparatus for the same.

Another embodiment of the present invention provides a method for measuring and feeding back channel information in order to support interference randomization, and an apparatus for the same.

Accordingly, the present invention provides inter-cell interference mitigation through inter-cell interference randomization.

A method for transmitting feedback information according to one embodiment of the present invention may include: receiving, from a base station, information on an interference pattern comprising an inter-cell interference measurement pilot signal and a trigger condition for a change to the interference pattern; measuring an interference randomization gain based on the inter-cell interference measurement pilot signal; determining whether to request a change to the interference pattern based on the interference randomization gain; requesting a change to the interference pattern from the base station, if it is determined that a change to the interference pattern is requested; and receiving, from the base station, a changed interference pattern and a changed trigger condition.

According to one embodiment of the present invention, there is provided a a method for adjusting an interference pattern and for adjusting a rank depending on a channel condition of a transmitter performing interference randomization, and an apparatus for the same.

According to another embodiment of the present invention, there is provided a method for measuring and feeding back channel information in order to support interference randomization, and an apparatus for the same.

Accordingly, there is provided inter-cell interference mitigation through inter-cell interference randomization.

### BRIEF DESCRIPTION OF THE DRAWINGS

FIG. 1 is a conceptual view illustrating the movement of a moving cell.

FIG. 2 is a conceptual view illustrating a problem that occurs when interference between a moving cell and a fixed cell is controlled by a conventional inter-cell interference (ICI) control method.

FIG. 3 illustrates that a signal is repetitively transmitted through different channels.

FIG. 4 illustrates a symbol and an interference signal received through a semi-static channel.

FIG. 5 illustrates a reception symbol and an interference signal according to one embodiment of the present invention.

FIG. 6 illustrates a symbol pattern according to one embodiment of the present invention.

FIG. 7a illustrates an IR pattern according to one embodiment of the present invention.

FIG. 7b illustrates an IR pattern according to another embodiment of the present invention.

FIG. 8 is a flowchart illustrating a method of transmitting a feedback signal for interference randomization according to one embodiment of the present invention.

FIG. 9a illustrates an IR pattern with an ICI measurement pilot signal allocated according to one embodiment of the present invention.

FIG. 9b illustrates an IR pattern with an ICI measurement pilot signal allocated according to another embodiment of the present invention.

FIG. 10a illustrates an IR pattern with an ICI measurement pilot signal allocated according to still another embodiment of the present invention.

FIG. 10b illustrates an IR pattern with an ICI measurement pilot signal allocated according to yet another embodiment of the present invention.

FIG. 11a illustrates an IR pattern with an ICI measurement pilot signal allocated according to still another embodiment of the present invention.

FIG. 11b illustrates an IR pattern with an ICI measurement pilot signal allocated according to yet another embodiment of the present invention.

FIG. 12 is a block diagram illustrating a wireless communication system according to one embodiment of the present specification.

### DESCRIPTION OF EXEMPLARY EMBODIMENTS

A wireless device may be stationary or mobile and may be denoted by other terms such as, user equipment (UE), mobile station (MS), user terminal (UT), subscriber station (SS), or mobile terminal (MT). Further, the terminal may be a portable device with a communication function, such as a cellular phone, a smartphone, a wireless modem, or a notebook computer, or may be a non-portable device, such as a personal computer (PC) or a vehicle-mounted device. A base station generally refers to a fixed station that communicates with a wireless device and may be denoted by other terms, such as evolved-NodeB (eNB), base transceiver system (BTS), or access point.

Hereinafter, applications of the present invention based on 3rd generation partnership project (3GPP) long term evolution (LTE) or 3GPP LTE-advanced (LTE-A) are described. However, these are merely examples, and the present invention may be applied to various wireless communication systems. Hereinafter, LTE includes LTE and/or LTE-A.

The present specification is described based on a communication network, and operations implemented in the communication network may be performed by a system (for example, a base station) responsible for the communication network in controlling the network and transmitting data or may be performed by a terminal linked to the network.

Recently, the commercialization of an LTE system as a next-generation wireless communication system has been actively supported. Use of this LTE system has been rapidly spreading with the recognition of a need to support not only voice services but also high-capacity services on user's demand with high quality, while guaranteeing the mobility of a terminal user. The LTE system provides low transmission delays, a high transmission rate, a high system capacity, and coverage enhancement.

The appearance of high-quality services drastically increases demands for wireless communication services. To actively deal with such increasing demands, it is first needed to increase the capacity of a communication system. To increase communication capacity in a wireless communication environment, a method of finding a new available frequency band and a method of increasing the efficiency of limited resources may be considered.

As a method of increasing the efficiency of limited resources, a multi-antenna transmission/reception technique has recently attracted great attention and is actively developing, in which a plurality of antennas is installed in a transceiver to obtain an additional spatial area for resource utilization, thus obtaining a diversity gain, or data is transmitted in parallel through each antenna to increase transmission capacity.

In a multiple-input multiple-output (MIMO) system, beamforming and precoding may be used as a method for increasing a signal-to-noise ratio (SNR). Beamforming and precoding are used to maximize an SNR through feedback information in a closed-loop system in which the feedback information is available to a transmitter.

Meanwhile, when channel information is not properly shared between adjacent cells, for example, as in a moving cell, which moves fast and thus is unable to quickly establish an interface with a neighboring cell at an appropriate time, or as in a femtocell restricted from sharing information with another cell, it may be difficult to apply inter-cell interference avoidance through a closed-loop coordinated multipoint (CoMP) technique.

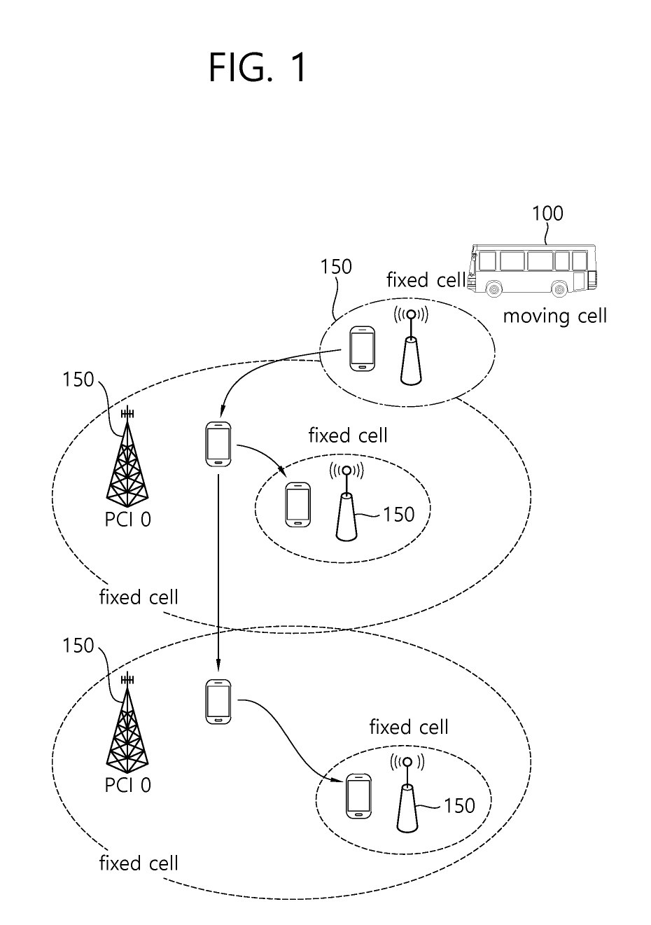

FIG. 1 is a conceptual view illustrating the movement of a moving cell.

In the following embodiments, a moving cell may denote a base station (BS) that moves, and a fixed cell may denote a BS that remains stationary at a fixed location. A moving cell may be denoted by a moving BS, and a fixed cell may be denoted by a fixed BS.

For example, a moving cell 100 may be a BS installed in a moving object, such as a bus. Based on buses running in Seoul, about 2000 moving cells 100 may be present. Therefore, interference between the moving cells 100 and fixed cells 150 is highly likely to occur in a current cellular network system.

For inter-cell interference (ICI) between fixed cells 150, resource division may be performed in view of the distance between a BS and a terminal in order to mitigate the inter-cell interference. Alternatively, interference may be mitigated by performing dynamic resource division or cooperative communication based on sharing channel information between cells.

However, it is difficult to apply the same methods for controlling interference between fixed cells 150 to the moving cell 100.

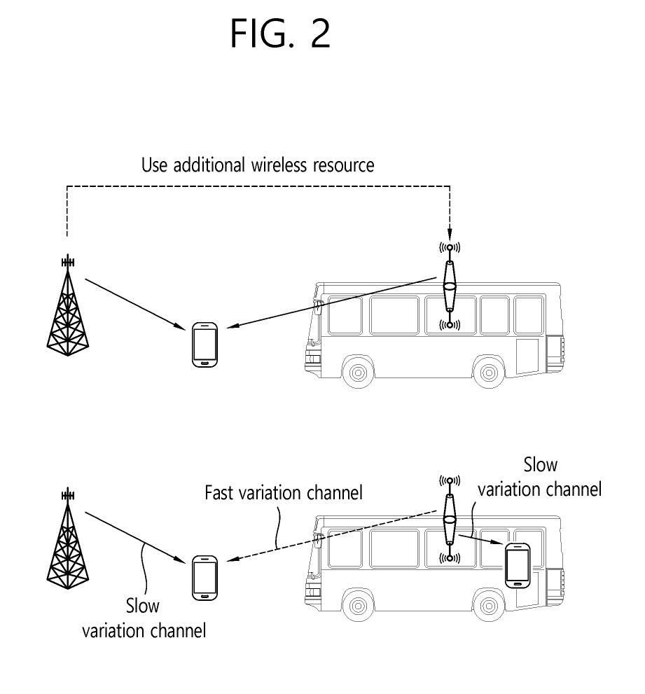

FIG. 2 is a conceptual view illustrating a problem that occurs when interference between a moving cell and a fixed cell is controlled by a conventional inter-cell interference control method.

In a moving cell, services are frequently provided through real-time traffic. Thus, interference control based on semi-static resource division may be inappropriate for the moving cell.

Referring to the upper part of FIG. 2, a moving cell may be connected to another cell based on a wireless backhaul. Thus, it may be difficult to use an inter-cell interference mitigation method based on dynamic resource division or cooperative communication through sharing of channel information. Specifically, in joint transmission (JT)/dynamic point selection (DPS), data to be transmitted to a terminal needs to be shared through a wired backhaul between BSs. However, data sharing between a moving cell and a fixed cell through the wireless backhaul needs the use of additional wireless resources and may be difficult to stably achieve according to a wireless channel condition. Thus, it may be difficult to mitigate interference between a fixed cell and a moving cell based on cooperative communication.

Referring to the lower part of FIG. 2, a channel between a moving cell and a fixed cell may be quickly changed by the movement of the moving cell. Therefore, it is required to develop a technique for controlling and reducing interference in a situation where sharing signals and interference channel information is not properly performed between cells.

In this environment, interference whitening through interference randomization or interference averaging, instead of interference avoidance, may be used.

Inter-cell interference randomizing is a method of randomizing interferences from neighboring cells to approximate inter-cell interference by additive white Gaussian noise (AWGN). Inter-cell interference randomizing may reduce the effect of a channel decoding process by a signal from another user, for example, based on cell-specific scrambling and cell-specific interleaving.

Inter-cell interference averaging is a method of averaging all interferences from neighboring cells or averaging inter-cell interferences at channel coding block level through symbol hopping.

According to an interference randomization technique according to one embodiment of the present invention, in transmitting desired signals through time/frequency/space resources, desired signals and interference signals are simultaneously received through some resources and only desired signals are received through some resources, thereby adjusting a ratio between desired signals and interference signals to vary in each resource. The signal-to-interference-plus-noise ratio (SINR) is changed in each resource, thereby obtaining a channel coding gain.

Further, the present invention may propose an interference randomization scheme that increases a variation of an interference signal received along with a desired signal without changing the use of resources may be proposed.

This interference randomization technique is applicable between transmitters performing spatial-diversity transmission, in which interference randomization is performed by setting different repeated transmission patterns of repeatedly transmitted symbols for BSs in order to obtain a spatial diversity gain.

An advanced interference randomization scheme of the present invention is a method of diversifying an interference signal affecting de-precoding of each symbol, changing the signal-to-interference ratio (SIR) of a signal in a quasi-static channel section, and securing interference diversity in the quasi-static channel section to obtain a diversity gain.

Generally, signal diversity refers to the standardization of received powers of signals by repetitively transmitting and receiving the same information through various channels. In signal diversity, an SINR change is reduced in a fading channel, and accordingly it is more likely to reconstruct information in the fading channel.

Interference diversity according to the present invention is conceptually similar to signal diversity, in which multiple interferences are simultaneously received through different channels to standardize the received powers of the interferences and an SINR change by interference is reduced. Accordingly, when the received power of an interference signal is high, the diversity gain of a signal is high.

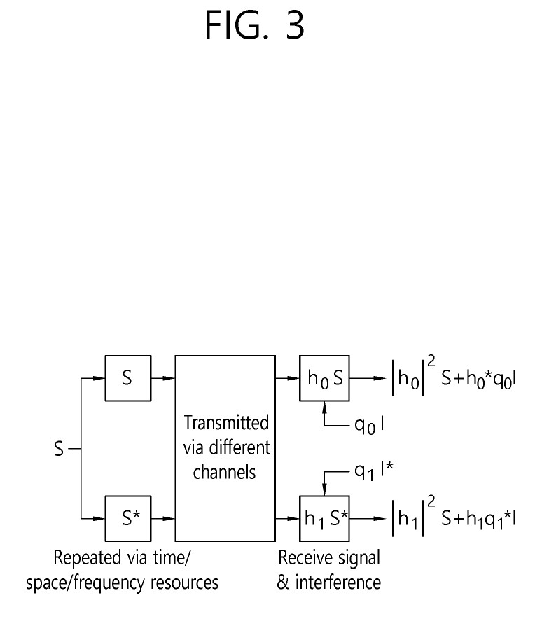

FIG. 3 illustrates that a signal is repetitively transmitted through different channels.

As illustrated, a transmitting end may transmit one transmission symbol (S, hereinafter, ‘first symbol’) and one modified symbol (S*, hereinafter, ‘second symbol’) to a receiving end, such as a terminal, through different channels, for example, different antennas. Here, the second symbol is the complex conjugate of the first symbol.

h₀ denotes a channel for a symbol between an antenna to transmit the first symbol and the receiving end, and h₁ denotes a channel for a symbol between an antenna to transmit the second symbol and the receiving end.

Here, I denotes an interference signal, and I* denotes the complex conjugate of the interference signal. q₀ denotes a channel for an interference signal between the antenna to transmit the first symbol and the receiving end, and q₁ denotes a channel for an interference signal between the antenna to transmit the second symbol and the receiving end.

The first symbol and the second symbol may be allocated to time, space, or frequency resources to be repetitively transmitted, and the transmitting end may receive a signal and interference.

As illustrated, when the first symbol is transmitted, the receiving end may receive |h₀|²S+h*₀q₀I along with an interference signal. When the second symbol is transmitted, the receiving end may receive |h₁|²S+h₁q*₁I along with an interference signal.

Ultimately, a symbol and an interference signal received by the receiving end may be represented by Equation 1.

$$\frac{{\vert {h}_{0} \vert}^{2} + {\vert {h}_{1} \vert}^{2}}{2} S + \frac{( {h}_{0}^{*} {q}_{0} + {h}_{1} {q}_{1}^{*} ) I}{2} \qquad [ Equation 1 ]$$

When a channel is in a semi-static state, in which the channel hardly changes, an interference diversity effect is reduced.

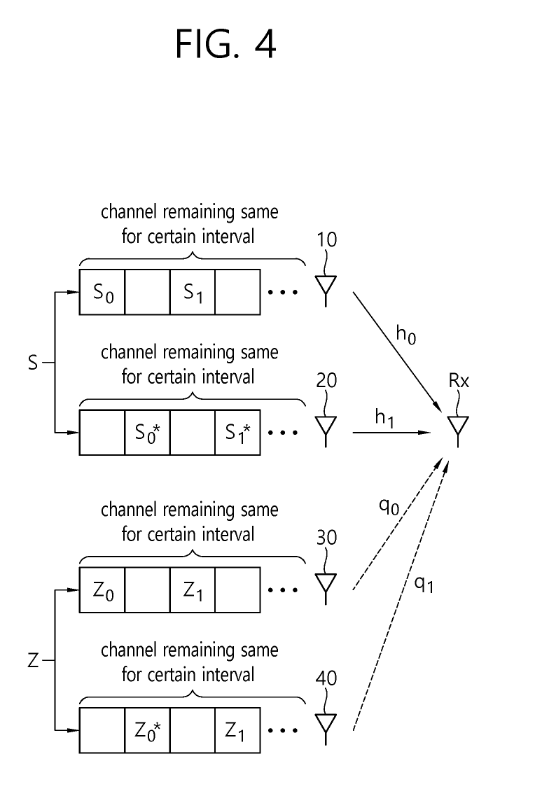

FIG. 4 illustrates a symbol and an interference signal received through a semi-static channel.

As illustrated, a terminal 100, which is a receiving end, may receive symbols (S) transmitted through two antennas and may receive signals transmitted through two antennas as interference signals (Z).

A first antenna 10 and a second antenna 20 may be antennas of a cell (hereinafter, ‘first cell’) providing a service to the terminal 100, and a third antenna 30 and a fourth antenna 40 may be antennas of a cell (hereinafter, ‘second cell’) transmitting symbols (Z) acting as interference signals to the terminal 100.

For example, when a fixed cell acts as an interference source to a terminal served by a moving cell, the first cell may be the moving cell and the second cell may be the fixed cell. On the contrary, when a moving cell acts as an interference source to a terminal served by a fixed cell, the first cell may be the fixed cell and the second cell may be the moving cell.

In FIG. 4, a row for symbols may denote time, space, or frequency resources for transmitting the symbols.

In a semi-static channel that remains the same for a certain interval, symbols S0, S1, etc. are transmitted through the first antenna 10, and modified symbols S₀*, S₁*, etc. of the symbols transmitted through the first antenna 10 are transmitted through the second antenna 20.

Symbols Z0, Z1, etc. are transmitted through the third antenna 30, and modified symbols Z₀*, Z₁*, etc. of the symbols transmitted through the third antenna 30 are transmitted through the fourth antenna 40.

For the terminal, the transmission symbols (S) transmitted in the first cell may be reception signals and the transmission symbols (Z) transmitted in the second cell may be interference signals.

Thus, in FIG. 4, h₀ denotes a channel between the first antenna 10 of the first cell and the terminal 100 served by the first cell; h₁ denotes a channel between the second antenna 20 of the first cell and the terminal 100 served by the first cell; q₀ denotes a channel between the third antenna 30 of the second cell and the terminal 100; and q₁ denotes a channel between the fourth antenna 40 of the second cell and the terminal 100.

Ultimately, reception symbols (Ŝ₀, Ŝ₁) received by the terminal may be represented by Equation 2.

$${\hat{S}}_{0} = {S}_{0} + \frac{( {h}_{0}^{*} {q}_{0} + {h}_{1} {q}_{1}^{*} ) {Z}_{0}}{{\vert {h}_{0} \vert}^{2} + {\vert {h}_{1} \vert}^{2}} \\ {\hat{S}}_{1} = {S}_{1} + \frac{( {h}_{0}^{*} {q}_{0} + {h}_{1} {q}_{1}^{*} ) {Z}_{1}}{{\vert {h}_{0} \vert}^{2} + {\vert {h}_{1} \vert}^{2}} \qquad [ Equation 2 ]$$

Referring to Equation 2, since the interference signals acting as interference to the reception symbols include the same coefficient

$$\frac{( {h}_{0}^{*} {q}_{0} + {h}_{1} {q}_{1}^{*} )}{( {\vert {h}_{0} \vert}^{2} + {\vert {h}_{1} \vert}^{2} )}$$

in the two symbols (Ŝ₀, Ŝ₁), it is considered that the symbols have the same SIR.

This means that a gain from the diversity of the entire packet is limited or reduced. When interference is significant in the semi-static channel, the terminal may continuously receive strong interference.

Hereinafter, a method of securing interference diversity by changing a repetitive pattern of an interference symbol, instead of with the same level of interference, is described.

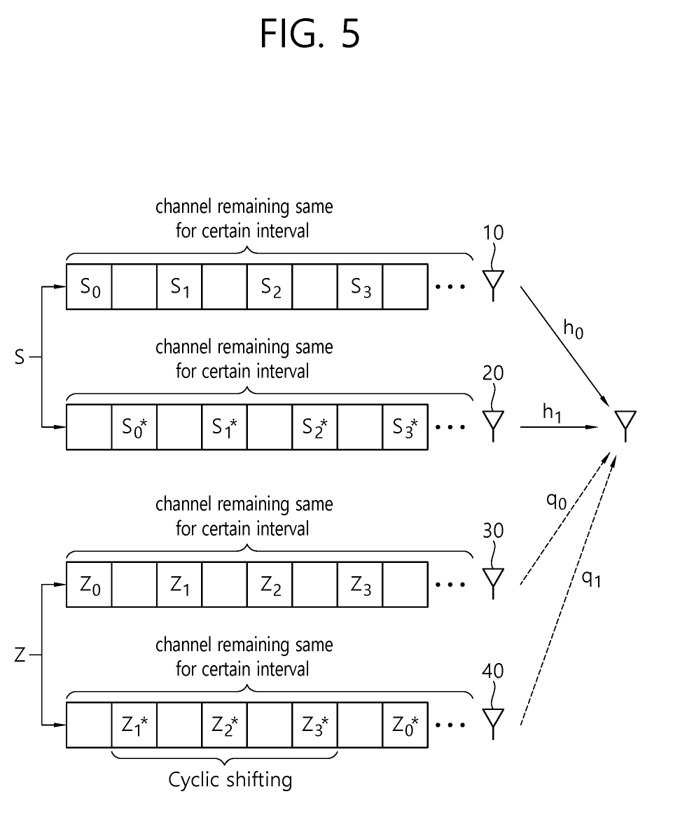

FIG. 5 illustrates a reception symbol and an interference signal according to one embodiment of the present invention.

As illustrated, in a semi-static channel that remains the same for a certain interval, symbols S₀, S₁, S₂, S₃, etc. are transmitted through a first antenna 10, and modified symbols S₀*, S₁*, S₂*, S₃**, etc. of the symbols transmitted through the first antenna are transmitted through a second antenna 20.

Symbols Z₀, Z₁, Z₂, Z₃, etc. are transmitted through a third antenna 30, and modified symbols Z₁*, Z₂*, Z₃*, Z₀*, etc. of the symbols transmitted through the third antenna are transmitted through a fourth antenna 40.

According to the embodiment of the present invention, the symbols transmitted through the fourth antenna are transmitted in order of Z₁*, Z₂*, Z₃*, Z₀*, etc. via the cyclic-shift of a conventional pattern of Z₀*, Z₁*, Z₂*, Z₃*. That is, a repetitive pattern of symbols that may act as interference signals to the terminal may be changed according to a certain order.

The repetitive pattern may be changed by a first cell and a second cell, which are transmitting ends, using different precoders.

When the repetitive pattern of symbols is changed, reception symbols (Ŝ₀, Ŝ₁) received by the terminal may be represented by Equation 3.

$${\hat{S}}_{0} = {S}_{0} + \frac{{h}_{0}^{*} {q}_{0} {Z}_{0} + {h}_{1} {q}_{1}^{*} {Z}_{2}}{{\vert {h}_{0} \vert}^{2} + {\vert {h}_{1} \vert}^{2}} \\ {\hat{S}}_{1} = {S}_{1} + \frac{{h}_{0}^{*} {q}_{0} {Z}_{1} + {h}_{1} {q}_{1}^{*} {Z}_{3}}{{\vert {h}_{0} \vert}^{2} + {\vert {h}_{1} \vert}^{2}} \qquad [ Equation 3 ]$$

Referring to Equation 3, the reception symbols (Ŝ₀, Ŝ₁) include different interference symbols acting as interference, which means that interference changes by each symbol in the semi-static interval. Accordingly, it is possible to secure interference diversity for a packet and to improve diversity performance.

Hereinafter, a specific precoding designing method for mitigating inter-cell interference is described.

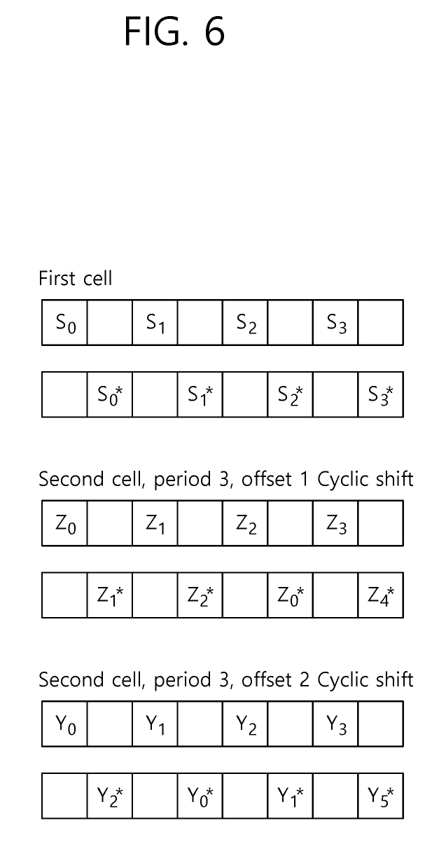

FIG. 6 illustrates a symbol pattern according to one embodiment of the present invention. Specifically, FIG. 6 shows that each BS, that is, each cell, performs precoding using a different repetitive pattern when symbols are repeated.

As illustrated, a first cell sequentially transmits symbols S and modified symbols S* of the symbols S with respect to the same signal through different antennas. That is, when symbol S₀ is transmitted through antenna 1 (A0), symbol S₀* is transmitted through antenna 2 (A1). Further, when symbol S₁ is sequentially transmitted through antenna 1 (A0), symbol S₁* is transmitted through antenna 2 (A1).

A pattern of symbols repeated by the first cell may be represented by a precoding matrix in Equation 4 or Equation 5.

$$\begin{matrix}[ \begin{matrix}{x}_{n} & 0 \\ 0 & {x}_{n}^{*}\end{matrix} ] & [ Equation 4 ] \\ [ \begin{matrix}{x}_{3 k} & 0 & {x}_{3 k + 1} & 0 & {x}_{3 k + 2} & 0 \\ 0 & {x}_{3 k} & 0 & {x}_{3 k + 1} & 0 & {x}_{3 k + 2}\end{matrix} ] & [ Equation 5 ]\end{matrix}$$

As shown in Equation 4 or Equation 5, when symbol S₀ is transmitted through one antenna, symbol S₀* is transmitted through another antenna. Further, when symbol S₁ is sequentially transmitted through the antenna used to transmit the symbol S₀, symbol S₁* is transmitted through the other antenna.

Meanwhile, a second cell may modify a symbol pattern as in the middle or bottom of FIG. 6. The second cell may repetitively transmit the symbol pattern through two antennas with a period of 3 and an offset set for the order of transmitted symbols.

In the middle symbol pattern of FIG. 6, the number of symbols in a repetitive pattern is 3, that is, the period is 3, and the offset of the order of transmitted symbols is set to 1. That is, symbols Z₀, Z₁, Z₂, Z₃, etc. may be sequentially transmitted through antenna 1 (A0), and modified symbols thereof may be transmitted through antenna 2 (A1) in a sequence of Z₁*, Z₂*, Z₀*, Z₄*, etc., instead of the preceding sequence of Z₀, Z₁, Z₂, Z₃, etc.

This pattern may be represented as a precoding matrix in Equation 6.

$$[ \begin{matrix}{x}_{3 k} & 0 & {x}_{3 k + 1} & 0 & {x}_{3 k + 2} & 0 \\ 0 & {x}_{3 k + 1} & 0 & {x}_{3 k + 2} & 0 & {x}_{3 k}\end{matrix} ] \qquad [ Equation 6 ]$$

In the bottom symbol pattern of FIG. 6, the number of symbols in a repetitive pattern is 3, that is, the period is 3, and the offset of the order of transmitted symbols is set to 2. That is, symbols Y₀, Y₁, Y₂, Y₃, etc. may be sequentially transmitted through antenna 1 (A0), and modified symbols thereof may be transmitted through antenna 2 (A1) in a sequence of Y₂*, Y₀*, Y₁*, Y₅*, etc., instead of the preceding sequence of Y₀, Y₁, Y₂, Y₃, etc.

This pattern may be represented as a precoding matrix in Equation 7.

$$[ \begin{matrix}{x}_{3 k} & 0 & {x}_{3 k + 1} & 0 & {x}_{3 k + 2} & 0 \\ 0 & {x}_{3 k + 2} & 0 & {x}_{3 k} & 0 & {x}_{3 k + 1}\end{matrix} ] \qquad [ Equation 7 ]$$

The same offset or different offsets may be applied to respective cells, and the same period or different periods may be applied to respective cells.

Further, cells using the same transmitting antenna port may use different sizes of precoders according to a cyclic shift period.

For example, in Equation 6 or Equation 7, a cyclic shift period of symbol repetition may be 3, which may be 4 or greater. When the period is set, an offset may be set to a value of up to “period-1.”

In precoding a signal, cells, which may act as interference sources to each other, may preset a procoder as in Equations 4 to 7 to variously modify a repetitive pattern of symbols. Accordingly, interference diversity may be secured, thus improving signal receiving capability and preventing a decrease in the performance of a received signal by strong interference.

The symbol patterns in FIG. 6 according to Equations 4 to 7 may be hereinafter referred to as a repetitive transmission pattern or ICI randomization (IR) pattern.

Meanwhile, when ICI is randomized by adjusting a repetitive transmission pattern of the same symbol as in the above embodiments, adjacent cells are required to use different repetitive transmission patterns in order to obtain an ICI randomization gain.

To this end, a method in which different repetitive transmission patterns are assigned to adjacent fixed cells and a moving cell-specific repetitive transmission pattern is assigned to a moving cell, a method for controlling adjacent mode cells to always have different repetitive transmission patterns through a network configuration, or a method in which a tremendous number of repetitive transmission patterns are designed to be selectively used by each cell to thereby reduce the probability that adjacent cells use the same repetitive transmission pattern may be applied.

To achieve interference randomization using the foregoing methods, a network having a high cell density or including a plurality of moving cells is required to design various repetitive transmission patterns and to allocate these patterns to each cell in order to perform ICI randomization.

In particular, in a region where a huge number of cells may be intensively distributed for a moment, for example, a bus stop, not only ICI received by a fixed cell but also ICI received by a moving cell needs randomizing, and thus an even greater number of repetitive transmission patterns needs to be generated.

The number of repetitive transmission patterns for ICI randomization, that is, IR patterns, may be determined based on an IR pattern size. To make a large number of IR patterns, an IR pattern needs to have a great length. When an IR pattern has a great length, the distance between repetitive transmission patterns increases.

That is, to perform ICI randomization a great number of times, a huge IR pattern needs to be designed. In this case, since the distance between resource elements for repetitively transmitting the same symbol is long, signal receiving performance in a frequency selective channel is reduced. Further, when an IR pattern is excessively large, ICI randomization may not be applied in transmitting a short packet.

One embodiment of the present invention proposes a method of deploying resources such that adjacent cells use different IR patterns, in which IR pattern capacity, that is, the number of IR patterns, is restricted to a finite number, and of performing IR pattern randomization to overcome a gain decrease that may occur by an IR pattern collision between adjacent cells and an IR pattern collision by a hidden cell, such as a high-speed moving cell.

Hereinafter, an IR pattern randomization method and a method for utilizing a demodulation pilot signal to signal an IR pattern are described.

A BS may define an IR pattern to be applied by the time/frequency resource block and may use two or more IR patterns in transmitting each packet.

In this case, an IR pattern applied to each time/frequency resource block may be determined on the unique value of each cell, such as a cell global ID, or may be determined through communications with neighboring cells.

Each IR pattern may basically be mapped to a frequency domain, and different IR patterns may be allocated to different time resources in each resource block.

Adjacent cells may use the same IR patterns in the same resource block. In this case, the adjacent cells may apply IR patterns allocated to time resources in the same resource block in different orders, thereby obtaining a gain from interference randomization.

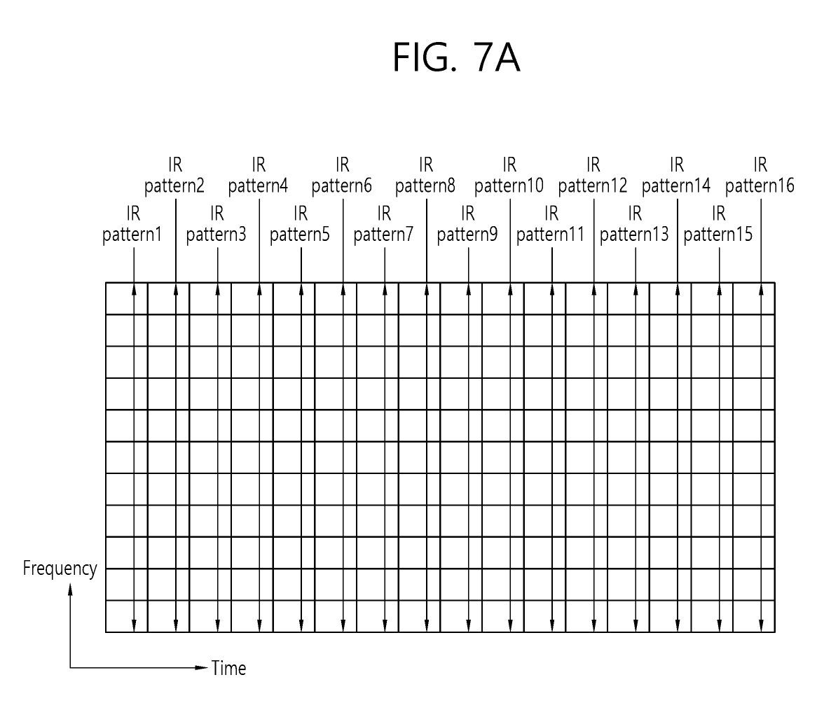

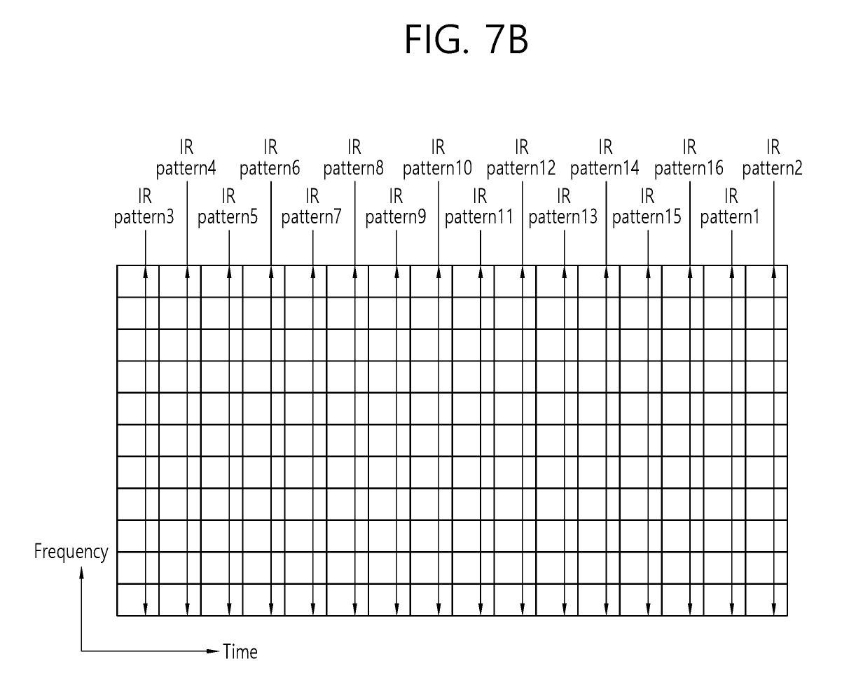

FIG. 7a and FIG. 7b illustrate IR patterns according to one embodiment of the present invention.

Specifically, FIG. 7a and FIG. 7b illustrate IR patterns allocated to the same radio resource of adjacent cells.

In resource blocks illustrated in FIGS. 7a and 7b, IR patterns are allocated to a frequency domain, and 16 different IR patterns are allocated to different time domains.

IR pattern 1 is allocated to a first time resource of the resource block in FIG. 7a, and IR pattern 2, IR pattern 3, . . . , IR pattern 16 are sequentially allocated. Meanwhile, from IR pattern 3, instead of IR pattern 1, to IR pattern 16 are sequentially allocated to from a first time resource of the resource block in FIG. 7b, and then IR pattern 1 and IR pattern 2 are allocated. That is, different IR patterns are allocated to equivalent time resources of the resource blocks assigned to the adjacent cells, thus achieving ICI randomization between the adjacent cells.

The IR patterns for the respective resource blocks are not randomly set in the entire time domain, but a set of randomly selected IR patterns, that is, IR pattern 1 to IR pattern 16, is repeated on a regular cycle, which is for restricting complexity in a UE recognizing an IR pattern.

An IR pattern may be determined based on two parameters, which are an IR pattern size, that is, the length of the IR pattern, and a cyclic shift offset.

An IR pattern size may refer to the number of frequency resource elements of a resource block, and a cyclic shift offset refers to an offset used for repeated transmission of symbols described with reference to FIG. 6.

A cyclic shift offset may be used as an index to identify a corresponding IR pattern in an IR pattern set. A cyclic shift offset may be represented by Mod(GCID+N+Nf+Nt, P−1), where GCID (global cell ID) may denote the identifier of a cell, N may denote a constant defined by each cell, Nf may denote a resource block frequency index, Nt may denote a resource block time index, and P may denote the length of an IR pattern.

The adjacent cells may have IR patterns of the same length, or the length of an IR pattern for each cell may be set to be integer times the length of an IR pattern for a neighboring cell. Accordingly, it may be prevented to apply the same repetitive transmission pattern to some symbols, despite different IR patterns, in IR pattern randomization.

IR pattern randomization may be performed by allocating different values of the two parameters, the IR pattern size and the cyclic shift offset, for resource blocks corresponding to respective cells.

More specifically, a parameter value for an IR pattern to be used for a resource group or a resource block as a reference point for each cell is differently allocated for each adjacent cell, and an IR pattern to be used for a different resource group or resource block is determined according to rules established in advance between a BS and a UE. This method may reduce complexity in IR pattern blind detection of a UE caused by IR pattern randomization.

First, a parameter value for an IR pattern applied to a reference point, for example, a first time resource of a resource block as a baseline, may be selected.

The parameter value may be the unique value of a cell or may be determined by negotiations with a neighboring cell.

An IR pattern to be applied to another resource block or resource group may be derived from the IR pattern applied to the reference point.

A method of selecting an IR pattern to be used for another resource block or resource group may be set through predefined rules, such as specifications, or may be transmitted in advance to a UE through system information or the like.

Then, an IR pattern to be used during an IR pattern period defined in a specification or set in advance may be derived. The same IR pattern may be repeated according to the IR pattern period.

An IR pattern to be allocated to a next time resource may be determined according to the IR pattern allocated to the first time resource in the resource block or resource group.

Meanwhile, in order to apply ICI randomization in the transmission of a channel or information that is transmitted without prior control information, for example, a physical downlink control channel (PDCCH), the present invention proposes IR pattern indication performed based on blind detection. In this case, a UE needs to recognize an IR pattern before a PDCCH is detected. To this end, a signaling method of adding IR pattern indication information to an existing demodulation pilot signal is proposed.

Although a demodulation pilot signal transmitted by each cell is transmitted to be UE-specific, demodulation pilot signals used by respective cells need to be orthogonal or semi-orthogonal in order to guarantee the pilot signal detection performance of a UE, and a UE may need to receive a demodulation pilot signal based on the physical ID of a cell or system information upon recognizing the physical ID or receiving the system information.

When these two conditions are satisfied, an existing demodulation pilot cell-specific sequence may be used as a signaling tool to indicate an IR pattern.

Similarly to a conventional method, the present invention generates a demodulation pilot sequence through a cell-specific parameter, for example, a physical cell ID (PCI), and then generates a cell and resource-specific pilot sequence by applying an IR pattern by each resource to the sequence.

For example, to generate a demodulation pilot signal corresponding to a resource group or resource block for which an IR pattern in a cyclic shift form having an IR pattern length of 4 and a cyclic shift offset of 1 is used, a BS may apply a cyclic shift with a period of 4 and an offset of 1 to a cell-specific sequence corresponding to the pilot signal. That is, an offset of 1 may be applied to repeated symbols forming the sequence, while a period of 4 may be repeated.

When an IR pattern is applied to a demodulation pilot cell-specific sequence, a pattern of a demodulation pilot signal allocated to a resource block may vary depending on an IR pattern change frequency and a demodulation pilot signal transmission frequency. Further, a pattern of a demodulation pilot signal allocated to a resource block may also vary depending on the maximum length of an IR pattern and the number of frequency domain resources used for the demodulation pilot signal.

Meanwhile, repeated transmissions of symbols need to be increased in order to raise a gain from interference randomization, which means an increase in the number of IR patterns.

In a transmission diversity, an increase in the number of IR patterns causes sensitive frequency selectivity, which means deterioration in performance or restriction in frequency use.

Further, in closed-loop MIMO, an increase in the number of IR patterns may reduce a resource selection gain, that is, a scheduling gain.

As no great IR processing gain may be needed or an IR pattern robust to frequency selectivity may be needed depending on channel conditions, it is necessary to properly change an IR processing gain depending on situations.

Hereinafter, a method in which a UE measures an IR gain according to channel frequency selectivity, an ICI level, and an IR pattern and reports the IR gain to a BS so that the BS as a transmitter may adjust an IR processing gain and a method of designing a pilot signal to enable such measurement are described.

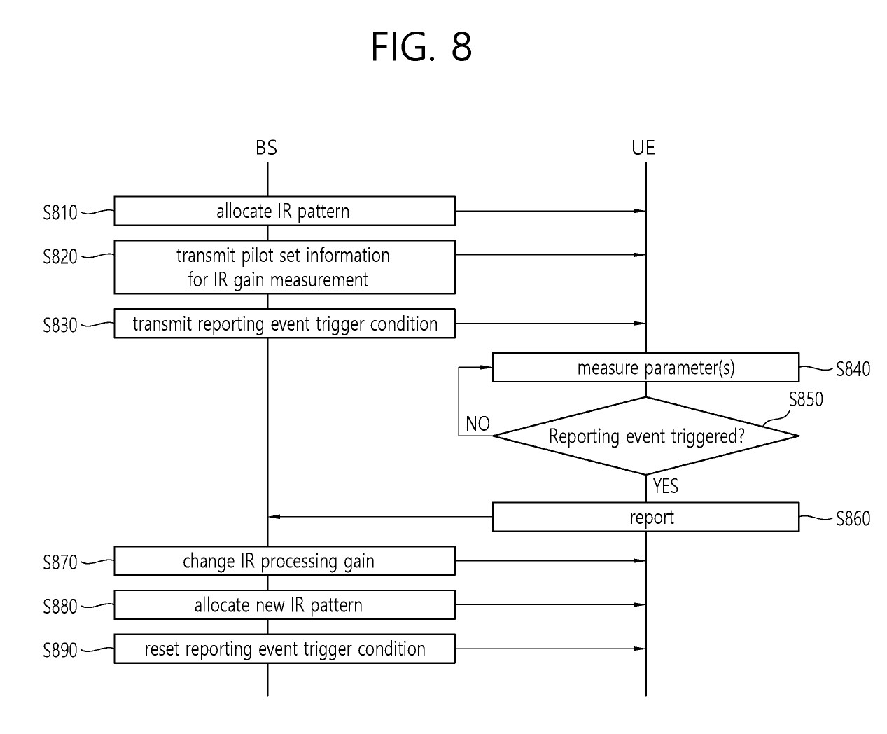

FIG. 8 is a flowchart illustrating a method of transmitting a feedback signal for interference randomization according to one embodiment of the present invention.

First, a BS may allocate a pilot signal for generating feedback information, that is, an IR pattern including a resource element for measuring a channel condition or interference, to an assigned resource (S810).

Rules for mapping a modulated symbol to each resource element are determined according to the IR patterns in FIG. 6. Some resource elements may be used to transmit an ICI measurement pilot signal, instead of data.

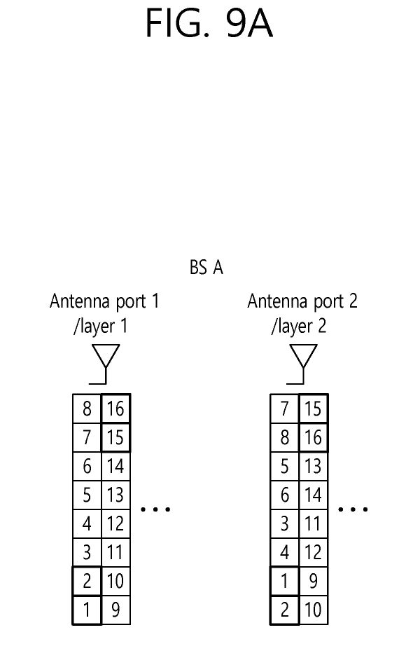

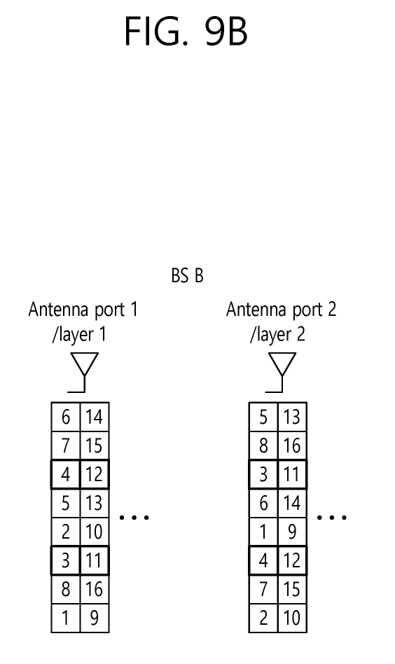

FIG. 9a and FIG. 9b illustrate IR patterns with an ICI measurement pilot signal allocated according to one embodiment of the present invention.

FIG. 9a illustrates an IR pattern generated by BS A, and FIG. 9b illustrates an IR pattern generated by BS B adjacent to BS A. A signal generated from BS A may act as an interference signal to BS B, and a signal generated from BS B may act as an interference signal to BS A.

As illustrated, BS A and BS B transmit signals through two antenna ports. FIG. 9a and FIG. 9b illustrate that symbols are transmitted through 16 resource elements included in a resource block formed on the time axis and the frequency axis.

Numbers shown in the 16 resource elements indicate random symbols and may be used to identify symbols in the IR patterns.

As illustrated in FIG. 9a, BS A may allocate the ICI measurement pilot signal to resource elements to which symbol 1, symbol 2, symbol 15, and symbol 16 are allocated. As illustrated in FIG. 9b, BS B may allocate the ICI measurement pilot signal to resource elements to which symbol 3, symbol 4, symbol 11, and symbol 12 are allocated.

According to one embodiment of the present invention, for ICI measurement, no signal may be transmitted (zero power pilot) in a resource element or a pilot signal with a remarkably lower transmission power than power used for data transmission may be allocated in a resource element.

Further, the BS transmits information on a pilot signal for IR gain measurement to a UE (S820).

The BS may transmit, to the UE, first pilot set information on a pilot signal for measurement of a channel condition thereof, for example, a channel gain or frequency selectivity, and second pilot set information on a pilot signal for measurement of ICI power or an IR gain representing ICI strength in the application of the IR pattern.

The first pilot set information may be transmitted from the BS to the UE through a process in which a table is set with respect to all cases of mapping a pilot signal to a resource element and an index of the table is transmitted to the UE through control information or system information.

Meanwhile, the BS may generate the second pilot set information in view of mapping a pilot signal using the position of a symbol repetitively transmitted according to the IR pattern.

According to one embodiment of the present invention, a pilot signal for an IR gain may be mapped in a regular pattern using the position of a repetitively transmitted symbol, and may be identified using this IR pattern.

That is, the second pilot set information may be expressed in a bitmap format indicating whether the pilot signal is transmitted at a position at which a specific symbol according to the IR pattern is transmitted. For example, in FIG. 9a, it may be expressed that the pilot signal is mapped to the positions of symbol 1, symbol 2, symbol 15, and symbol 16.

Meanwhile, when the IR pattern is repeated and a bitmap is used to indicate whether the ICI pilot signal is mapped to the position of a resource element to which a specific symbol in each IR pattern is mapped, if the resource block includes a great number of resource elements, signaling overhead of an increase in bitmap size may occur.

According to another embodiment of the present invention, a simple bitmap may be used to reduce such signaling overhead.

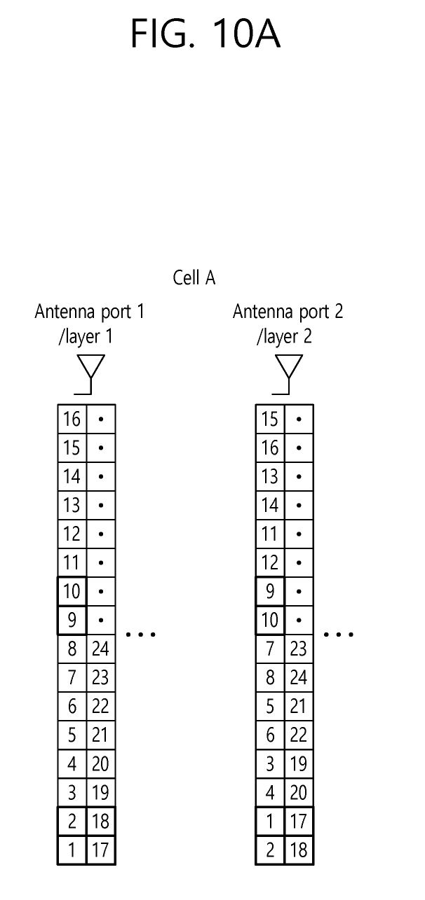

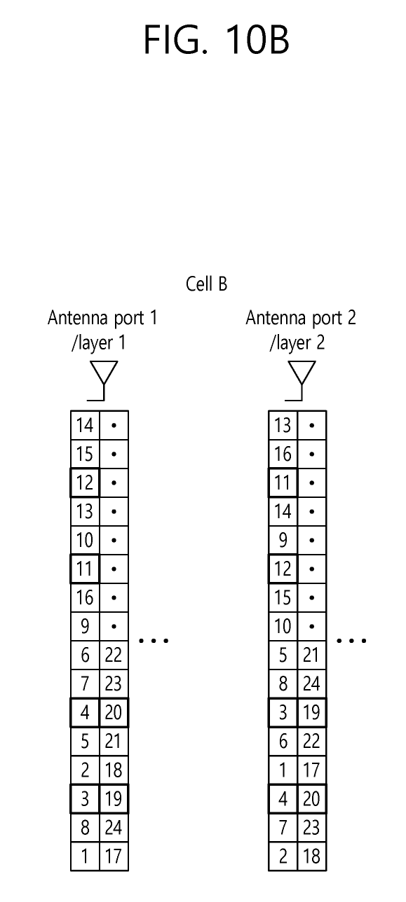

FIG. 10a and FIG. 10b illustrate IR patterns with an ICI measurement pilot signal allocated according to another embodiment of the present invention. FIG. 10a illustrates an IR pattern generated by BS A, and FIG. 10b illustrates an IR pattern generated by BS B adjacent to BS A.

As illustrated in FIG. 10a, BS A allocates symbols 1 to 16 to resources of a first antenna port and a second antenna port on the frequency axis during a specified time and allocates symbols 17 to 32 after the specified time.

An IR pattern of eight symbols in one set is repetitively allocated to the first antenna port and the second antenna port.

Symbols allocated to the first antenna are sequentially allocated from first to eighth symbols, without changing the order of symbols, while symbols allocated to the second antenna port are allocated with the first and second symbols transposed.

That is, although symbols 1 to 32 are also allocated to the second antenna port, symbols 1 and 2 and symbols 7 and 8 are allocated to the positions of different resource blocks, and symbols 15 and 16 and symbols 31 and 32 are allocated to the positions of different resource blocks.

In this symbol-mapped resource structure, the ICI pilot signal may be mapped to the positions to which symbols 1 and 2 are allocated, which may be represented by a bitmap of 8-bit information “11000000.”

As illustrated in FIG. 10b, BS B allocates symbols 1 to 16 to resources of a first antenna port and a second antenna port on the frequency axis during a specified time and allocates symbols 17 to 32 after the specified time.

Similarly to FIG. 10a, an IR pattern of eight symbols in one set is repetitively allocated to the first antenna port and the second antenna port in FIG. 10b.

Symbols are allocated to the first antenna port in order of “symbol 1, symbol 8, symbol 3, symbol 2, symbol 5, symbol 4, symbol 7, and symbol 6,” and this order is also repeatedly applied to the other symbols (symbols 9 to 16, symbols 17 to 24, and symbols 25 to 32).

Symbols are allocated to the second antenna port in order of “symbol 2, symbol 7, symbol 4, symbol 1, symbol 6, symbol 3, symbol 8, and symbol 5,” and this order is also repeatedly applied to the other symbols (symbols 9 to 16, symbols 17 to 24, and symbols 25 to 32).

In this symbol-mapped resource structure, the ICI pilot signal may be mapped to the positions to which symbols 3 and 4 are allocated, which may be represented by a bitmap of 8-bit information “00110000.”

BS A may transmit “11000000” as second pilot set information to the UE, and BS B may transmit “00110000” as second pilot set information to the UE.

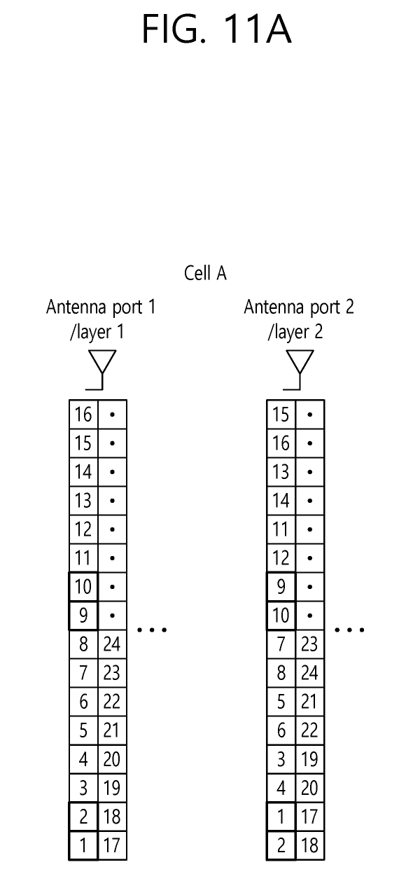

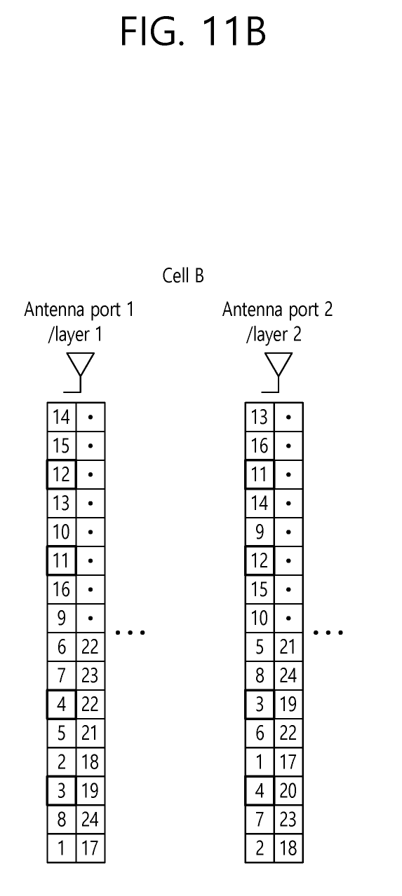

FIG. 11a and FIG. 11b illustrate IR patterns with an ICI measurement pilot signal allocated according to still another embodiment of the present invention. FIG. 11a illustrates an IR pattern generated by BS A, and FIG. 11b illustrates an IR pattern generated by BS B adjacent to BS A.

According to the present embodiment, defining the number of IR pattern repeats in a resource block as N, an IR pattern with the ICI pilot signal allocated may be identified using an N-bit bitmap. Further, information on the ICI pilot signal may be generated through another bitmap indicating which symbol in each pattern the ICI pilot signal is allocated to.

FIG. 11a and FIG. 11b have the same resource allocation structure as FIG. 10a and FIG. 10b. That is, the same symbols are allocated to specified time and frequency domains.

However, as in FIG. 11a, the ICI pilot signal may be transmitted through resource elements to which symbol 1, symbol 2, symbol 9, and symbol 10 are allocated. That is, the ICI pilot signal is transmitted in first and second pattern among the repeated IR patterns, while no ICI pilot signal is transmitted in third and fourth patterns.

Second pilot set information according to the present embodiment may be generated as a first bitmap to identify the repeated patterns and a second bitmap to identify the ICI pilot signal in the IR patterns.

Applying this to FIG. 11a, since the ICI pilot signal is included in the first and second patterns among the repeated four patterns, the first bitmap is a four-bit form of “1100.” Further, since the pilot signal may be allocated to resource elements where symbol 1 and symbol 2 are positioned in the repeated IR patterns, the second bitmap may be represented by “11000000.”

BS B also transmits the ICI pilot signal via the first and the second patterns among the repeated IR patterns but includes no ICI pilot signal in the third and fourth patterns.

The ICI pilot signal transmitted through the first antenna port and the second antenna port may be mapped to resource elements to which symbol 3, symbol 4, symbol 11, and symbol 12 are mapped.

Representing this resource allocation structure of FIG. 11b with the first bitmap and the second bitmap, since the ICI pilot signal is included in the first and second patterns among the repeated four patterns, the first bitmap is a four-bit form of “1100.” Further, since the pilot signal may be allocated to resource elements where symbol 3 and symbol 4 are positioned in the repeated IR patterns, the second bitmap may be represented by “00110000.”

Finally, the BS may transmit, to the UE, information on a condition for the UE to request a pattern change based on a measured parameter, that is, a reporting event trigger condition (S830).

When an IR gain is not sufficiently high or an IR pattern is large as compared with frequency selectivity, that is, coherent bandwidth, the BS may transmit information on a condition for requesting an IR pattern change to the UE.

An IR gain may be determined to be low depending on various conditions and environments. For example, when the ratio of ICI power after received (Rx) power combining to ICI Rx power is lower than a specific threshold (Th_IR_gain) and a channel gain measured with a pilot signal for estimating a channel gain is lower than a preset threshold, it may be determined that the IR gain is not sufficiently high.

Alternatively, according to various embodiments, when the ratio of ICI power after Rx power combining is lower than a specific threshold (Th_IR_SIR), the ratio of ICI Rx power is lower than a specific threshold (Th_ICI_SIR), ICI Rx power is greater than a specific threshold (Th_ICI_peak), or ICI power after Rx power combining is greater than a specific threshold (Th_IR_peak), it may be determined that the IR gain is not sufficiently high.

The BS may transmit, to the UE, information on these conditions and information on the threshold of the ICI power ratio (Th_IR_gain) and the specific thresholds (Th_IR_SIR), (Th_ICI_SIR), (Th_ICI_peak), or (Th_IR_peak). One or more of the specific thresholds may be transmitted.

Alternatively, when ICC power after IR combining is greater than a specific threshold (Th_IR), the BS may transmit information on the threshold (Th_IR) to the UE so that the UE may request an IR pattern change.

The pilot set information or reporting event trigger condition, which is transmitted from the BS to the UE, may be newly set or changed whenever the IR pattern is changed. Alternatively, the pilot set information or reporting event trigger condition may be changed or set through a previously set lookup table.

For convenience of description, it is shown that operations S810 to operation 830 are sequentially performed. However, these operations may be performed at the same time or in parallel and may also be performed in a different order.

Returning to FIG. 8, when the BS transmits the IR pattern information, the pilot signal set information for IR gain measurement, and the reporting event trigger condition to the UE, the UE measures a parameter for generating feedback information based on the information transmitted from the BS (S840).

The UE may measure a gain of a channel or virtual channel and channel frequency selectivity. These two parameters may be measured through a pilot signal for reporting channel state information (CSI).

Further, the UE may measure ICI strength, that is, ICI Rx power, and an IR gain representing ICI strength in the application of the IR pattern. These two parameters may be measured through a new pilot signal generated for interference measurement, for example, a pilot signal transmitted through the IR patterns illustrated in FIGS. 9a to 10b.

The UE may estimate ICI Rx power by measuring the energy of the pilot signal transmitted through the IR patterns illustrated in FIGS. 9a to 10b. For example, when BS A transmits no signal through a resource to which an ICI pilot signal is allocated, a signal measured through the resource acts as an interference signal.

Further, the UE may perform Rx power combining according to the IR pattern on a signal received through this ICI resource and may measure the energy of the signal after power combining to estimate ICI power. That is, the UE may estimate an IR gain through a difference between Rx power according to the IR pattern and ICI Rx power.

The UE may determine whether a channel state and an interference state based on the measured parameters satisfy the reporting event trigger condition transmitted from the BS (S850).

As a result, when the channel state and the interference state do not satisfy the reporting event trigger condition, the UE receives a data signal and a pilot signal transmitted from the BS and measures a parameter for generating feedback information.

When the channel state and the interference state satisfy the reporting event trigger condition, that is, when an event to request an IR pattern change occurs, the UE reports the occurrence of the event to the BS (S860).

When the IR gain is not sufficiently high or the IR pattern is large as compared with frequency selectivity, the BS may transmit information on a condition for requesting an IR pattern change to the UE.

The UE may determine cases where the IR gain is not high based on the thresholds received in operation S830, in which case the UE may request an IR gain increase.

Alternatively, when the IR pattern is large as compared with frequency selectivity, the UE may request an IR gain decrease.

When receiving a report on an event trigger from the UE, the BS changes an IR processing gain and changes the IR pattern based on the IR processing gain (S870).

When an IR gain increase is requested from the UE, the BS may increase the number of symbol repetition times or may increase the length of the IR pattern to randomize interference by a greater number of cells.

When an IR gain decrease is requested from the UE, the BS may reduce the number of symbol repetition times or may reduce the maximum distance between repetitively transmitted symbols (distance between resource elements mapped to a pilot signal for ICI) in order to decrease the length of the IR pattern. A short IR pattern length may reduce an IR gain.

Te changed IR pattern is transmitted to the UE through a newly allocated resource (S880), and the reporting event trigger condition may be reset corresponding to the changed IR pattern (S890).

As described above, the present invention provides a method for performing signaling to adjust an interference pattern depending on a channel condition of a transmitter and for measuring and feeding back channel information based on signaling, and an apparatus for the same.

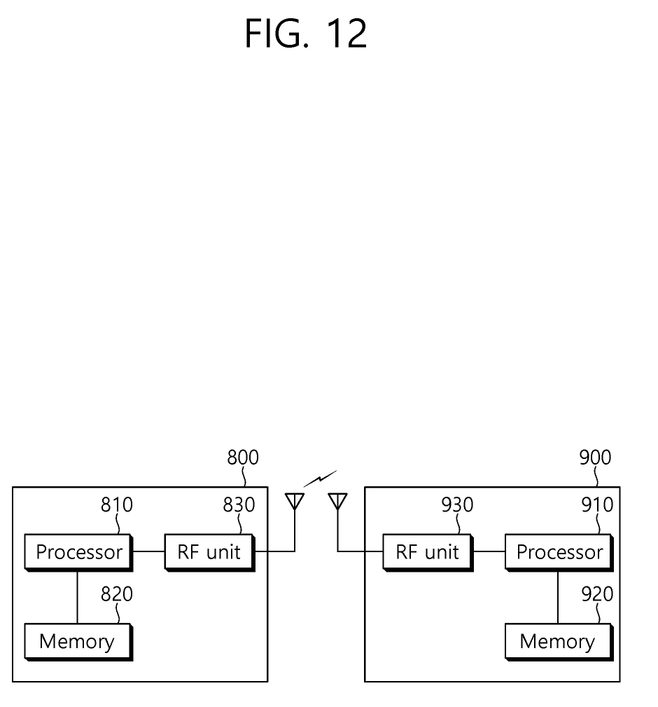

FIG. 12 is a block diagram of a wireless communication system according to one embodiment of the present invention.

A BS 800 includes a processor 810, a memory 820, and a radio frequency (RF) unit 830. The processor 810 implements the proposed functions, procedures, and/or methods. Layers of wireless interface protocols may be implemented by the processor 810. The memory 820 is connected with the processor 810 and stores various pieces of information to operate the processor 810. The RF unit 830 is connected with the processor 1110 and transmits and/or receives radio signals.

A terminal 900 includes a processor 910, a memory 920, and a radio frequency (RF) unit 930. The processor 910 implements the proposed functions, procedures, and/or methods. Layers of wireless interface protocols may be implemented by the processor 910. The memory 920 is connected with the processor 910 and stores various pieces of information to operate the processor 910. The RF unit 930 is connected with the processor 1110 and transmits and/or receives radio signals.

The processor may include an application-specific integrated circuit (ASIC), a separate chipset, a logic circuit, and/or a data processing unit. The memory may include a read-only memory (ROM), a random access memory (RAM), a flash memory, a memory card, a storage medium, and/or other equivalent storage devices. The RF unit may include a base-band circuit for processing a radio signal. When the embodiment of the present invention is implemented in software, the aforementioned methods can be implemented with a module (i.e., process, function, etc.) for performing the aforementioned functions. The module may be stored in the memory and may be performed by the processor. The memory may be located inside or outside the processor, and may be coupled to the processor by using various well-known means.

As described above, the present invention provides a method and a device enabling a terminal to select a wireless node for an uplink according to a predetermined condition when wireless connection is possible through different wireless networks.

In the above-described exemplary system, although the methods have been described in the foregoing embodiments on the basis of a flowchart in which steps or blocks are listed in sequence, the steps of the present invention are not limited to a certain order. Therefore, a certain step may be performed in a different step or in a different order or concurrently with respect to that described above. Further, it will be understood by those ordinary skilled in the art that the steps of the flowcharts are not exclusive. Rather, another step may be included therein or one or more steps may be deleted within the scope of the present invention.

1. A method for transmitting, by a user equipment (UE), feedback information to support interference randomization, the method comprising:
receiving, from a base station, information on an interference pattern comprising an inter-cell interference measurement pilot signal and a trigger condition for a change to the interference pattern;
measuring an interference randomization gain based on the inter-cell interference measurement pilot signal;
determining whether to request a change to the interference pattern based on the interference randomization gain;
requesting a change to the interference pattern to the base station, if it is determined that a change to the interference pattern is requested; and
receiving, from the base station, a changed interference pattern and a changed trigger condition.

2. The method of claim 1, wherein the information on the interference pattern is a bitmap indicating that the inter-cell interference measurement pilot signal is mapped to a symbol allocated to the interference pattern.

3. The method of claim 1, wherein the requesting of the change to the interference pattern comprises requesting an increase in length of the interference pattern when the interference randomization gain is smaller than a predetermined threshold.

4. The method of claim 3, wherein the predetermined threshold is transmitted through the trigger condition.

5. The method of claim 1, wherein the requesting of the change to the interference pattern comprises requesting a decrease in length of the interference pattern when the interference pattern is large as compared with frequency selectivity.

6. A user equipment (UE) for transmitting feedback information to support interference randomization, the UE comprising:
a signal transceiver; and
a processor connected to the signal transceiver,
wherein the processor receives, from a base station, information on an interference pattern comprising an inter-cell interference measurement pilot signal and a trigger condition for a change to the interference pattern; measures an interference randomization gain based on the inter-cell interference measurement pilot signal; determines whether to request a change to the interference pattern based on the interference randomization gain; requests a change to the interference pattern to the base station, if it is determined that a change to the interference pattern is requested; and receives, from the base station, a changed interference pattern and a changed trigger condition.

7. A method for receiving, by a base station, feedback information to support interference randomization, the method comprising:
transmitting, to a user equipment (UE), information on an interference pattern comprising an inter-cell interference measurement pilot signal and a trigger condition for a change to the interference pattern;
receiving, from the UE, a request for a change to the interference pattern, if a change to the interference pattern is requested by the UE based on an interference randomization gain, wherein the interference randomization gain is measured by the UE based on the inter-cell interference measurement pilot signal; and
transmitting, to the UE, a changed interference pattern and a changed trigger condition.

8. The method of claim 7, the method further comprising:
changing an interference randomization gain when the request for the change to the interference pattern is received;
changing an interference pattern based on a changed interference randomization gain; and
changing a trigger condition corresponding to a changed interference pattern.

9. The method of claim 7, wherein the information on the interference pattern is a bitmap indicating that the inter-cell interference measurement pilot signal is mapped to a symbol allocated to the interference pattern.

10. The method of claim 7, wherein the request for the change to the interference pattern includes a request for increasing length of the interference pattern when the interference randomization gain is smaller than a predetermined threshold.

11. The method of claim 10, wherein the predetermined threshold is transmitted through the trigger condition.

12. The method of claim 7, wherein the request for the change to the interference pattern includes a request for decreasing length of the interference pattern when the interference pattern is large as compared with frequency selectivity.
